(19) United States
(12) Patent Application Publication
(10) Pub. No.: US 2010/0185525 A1
(43) Pub. Date: Jul. 22, 2010

(54) CONTROLLING PRESENTATION OF PURCHASING INFORMATION BASED ON ITEM AVAILABILITY

(76) Inventors: John Hazen, Huntington Beach, CA (US); Phaedrus Ronchi, Huntington Beach, CA (US)

Correspondence Address: BANNER & WITCOFF, LTD., 1100 13th STREET, N.W., SUITE 1200, WASHINGTON, DC, 20005-4051, US

(21) Appl. No.: 12/355,366

(22) Filed: Jan. 16, 2009

(51) Int. Cl. G06Q 30/00; G06Q 10/00

(52) U.S. Cl. 705/26; 705/1.1

(57) ABSTRACT

Systems and methods may relate to receiving a request for an electronic document comprising content, retrieving the electronic document associated with the request, and processing the electronic document to identify an inventory tag that identifies an item in the content. The systems and methods may further relate to obtaining availability information of the item associated with the inventory tag, updating the electronic document to include the availability information, and transmitting the electronic document including the availability information.

### FIELD

Example embodiments of the invention generally relate to inventory management. More specifically, example embodiments of the invention relate to accessing availability information to determine whether to present purchasing information.

### BACKGROUND

The Internet has been used to provide access to information through providing a computer access to webpages. Webpages have also been used to offer items for sale, such as clothing, food, bicycles, etc.

### BRIEF SUMMARY

The following presents a simplified summary of some example embodiments of the invention in order to provide a basic understanding of some example embodiments of the invention. This summary is not an extensive overview, and is not intended to identify key or critical elements or to delineate the scope of the claims. The following summary merely presents some concepts and example embodiments in a simplified form as a prelude to the more detailed description provided below.

Some example embodiments may relate to aspects of systems and methods for receiving a request for an electronic document comprising content, retrieving the electronic document associated with the request, processing the electronic document to identify an inventory tag that identifies an item in the content, obtaining availability information of the item associated with the inventory tag, updating the electronic document to include the availability information, and transmitting the electronic document including the availability information.

Other example embodiments may relate to aspects of systems and methods for generating a request for an electronic document comprising content, receiving the electronic document comprising availability information indicating whether an item to be presented in the content is in inventory, presenting the electronic document comprising a field associated with the item, and when an indicator is positioned relative to the field, processing the availability information to determine if the item is in inventory, wherein if the item is in inventory, presenting a link to permit purchase of the item.

Further example embodiments may relate to aspects of systems and methods for receiving content for presentation in an electronic document, receiving an inventory tag identifying an item included in the content, the inventory tag being associated with a posting user identifier, receiving a purchase request for the item, the purchase request comprising the posting user identifier, and updating incentive information associated with the posting user identifier.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates an electronic document in accordance with example embodiments of the present disclosure.

FIG. 2 illustrates content including multiple fields associated with presented items in accordance with example embodiments of the present disclosure.

FIG. 3 illustrates an example of presenting a purchasing link in accordance with example embodiments of the present disclosure.

FIG. 4 illustrates a system in accordance with example embodiments of the present disclosure.

FIG. 5 illustrates a web server in accordance with example embodiments of the present disclosure.

FIG. 6 illustrates an electronic document database in accordance with example embodiments of the present disclosure.

FIG. 7 illustrates an inventory server in accordance with example embodiments of the present disclosure.

FIG. 8 illustrates an inventory database in accordance with example embodiments of the present disclosure.

FIG. 9 illustrates a method to receive and respond to a request for an electronic document in accordance with example embodiments of the present disclosure.

FIG. 10 illustrates a method for retrieving an electronic document in accordance with example embodiments of the present disclosure.

### DETAILED DESCRIPTION

In the following description of the various embodiments, reference is made to the accompanying drawings, which form a part hereof, and in which is shown by way of illustration various embodiments in which one or more example embodiments of the invention may be practiced. It is to be understood that other embodiments may be utilized and structural and functional modifications may be made without departing from the scope of the present invention.

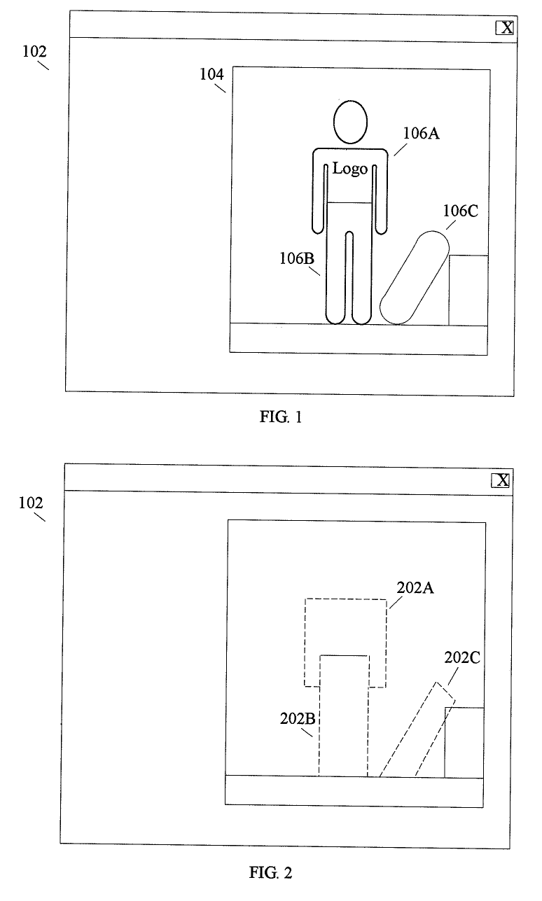

FIGS. 1 illustrates an electronic document 102 in accordance with example embodiments of the present disclosure. Example embodiments may make availability determinations about items to be displayed in the electronic document 102 before displaying purchasing links. In an example embodiment, the electronic document 102 may include content 104 displaying one or more items 106. The electronic document 102 may be a webpage, for example. The electronic document 102 also may be any data type suitable for presenting information to a user. The content 104 may be a photograph, for example, and/or also may be video. An item 106 may be any product or service available for purchase from a provider. Examples of items that are products may include t-shirts, pants, shoes, hats, food, etc. Examples of services may be lawn care, travel, food delivery, etc. Examples of providers may include merchants, manufacturers, etc. The electronic document 102 may determine whether any of the items 106 are currently in inventory before presenting a purchasing link associated with an item 106, as discussed in further detail below.

In the depicted example, the content 104 is a picture of a person including multiple items 106. Item 106A is a shirt and item 106B are pants being worn by the person, and item 106C is a snowboard next to the person. The items 106A-C may each be associated with a field that may or might not be displayed in the content 104.

FIG. 2 illustrates content 104 including multiple fields 202 associated with presented items 106 in accordance with example embodiments of the present disclosure. In FIG. 2, the person and the snowboard have been removed from FIG. 1 to better illustrate the fields 202. The fields 202 may correspond to the location in the content 104 where each item 106 is being displayed. For example, field 202A may correspond to the location in the content 104 where the shirt (i.e., item 106A) is displayed, field 202B may correspond to the location in the content 104 where the pants (i.e., item 106B) are displayed, and field 202C may correspond to the location in the content 104 where the snow board (i.e., item 202C) is displayed. A field 202 also may be referred to as a hot spot. The fields 202 may be static if the content 104 is a photograph, and the fields 202 may adjust to correspond to a current location of an item 106. For example, the content 104 may be video and the person depicted in FIG. 1 may move over time. The field 202A corresponding to the person's shirt (i.e., item 106A) may adjust as the person moves to be co-located over the item 106A. When presenting the electronic document 102, a determination may be made whether each item 106 in the content 104 is available in inventory for purchase. If available, a purchasing link may be displayed permitting a user to purchase the item 106. If unavailable, the purchasing link might not be displayed.

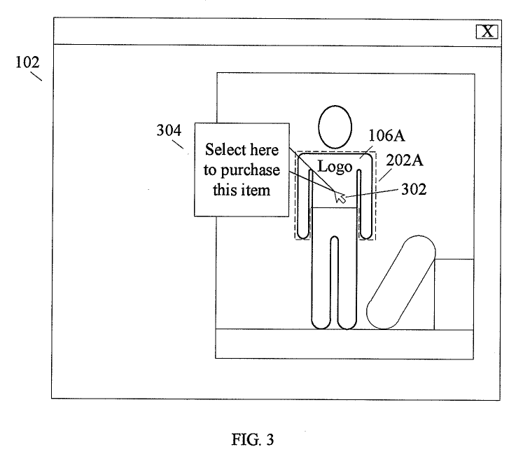

FIG. 3 illustrates an example of presenting a purchasing link in accordance with example embodiments of the present disclosure. A user may cause an indicator 302 to be positioned relative to an item 106 presented in the content 104. For example, a user input device (not shown), such as, but not limited to, a computer mouse, a tracking ball, or a key pad may cause the indicator 302 to move about the electronic document 102. The user input device may cause the indicator 302 to hover over an item 106 of interest. In the depicted example, the indicator 302 is hovering over a shirt (i.e., item 106A) and its associated field 202A. If the item 106 is available in inventory for purchase, a purchasing link 304 may be displayed and the user may select the purchasing link 304 to purchase the item 106. In the depicted example, the purchasing link 304 may include text instructing the user to select the text to purchase the item (i.e., Select here to purchase this item). A system of determining whether to present the purchasing link 304 is discussed below.

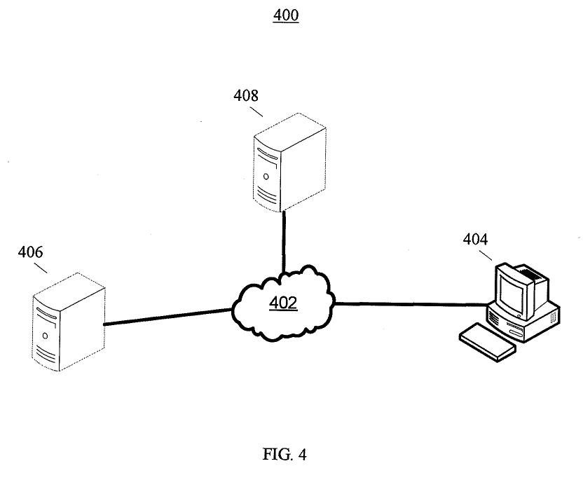

FIG. 4 illustrates a system in accordance with example embodiments of the present disclosure. The system 400 may include a network 402, a user terminal 404, an inventory server 406, and a web server 408. Each of the user terminal 404, the inventory server 406, and the web server 408 may be communicatively coupled to the network 402. Each of the user terminal 404, the inventory server 406, and the web server 408 may have a processor and may have a computer-readable memory storing computer-executable instructions to perform the methods and functions described herein. The memory may be implemented with any combination of read only memory modules or random access memory modules, optionally including both volatile and nonvolatile memory. Also, some or all computer executable instructions may be embodied in hardware or firmware (not shown). Further, the inventory server 406 and the web server 408 are depicted as separate devices, but instead may be a single device. The operations, functions, and methods that each of the user terminal 404, the inventory server 406, and the web server 408 perform may be divided across further devices or the various devices may be integrated with one another.

The user terminal 404 may be a computer, as depicted, but also may be other devices capable of communication with a network, such as, but not limited to, a mobile phone, a personal digital assistant, a set top box, etc. The web server 408 may store the electronic document 102 and may transmit the electronic document 102 in response to requests from the user terminal 404. The inventory server 406 may contain data indicating the availability of items 106 to be presented in the electronic document 102.

Numerous technologies may implement the communication between the user terminal 404, the web server 408, and the inventory server 406 via the network 402. In an example embodiment, asynchronous JavaScript and eXtensible Markup Language (XML), known as (AJAX) may be used. Other protocols also may be used. For example, the electronic document 102 may include one or more stylesheets and the request may for the electronic document 102 may be an AJAX call to the web server 408.

Initially, the user terminal 404 may transmit a request for the electronic document 102 to the web server 408. For example, the user terminal 404 may include a web browser, and the request may be for an electronic document 102 that is a web page. In addition to requesting the electronic document 102, the request may include a user profile. The user profile may include information about the user of the user terminal 404, such as, but not limited to, a clothing size. For example, the user terminal 404 may prompt the user to populate a user profile with information about the user. The user profile may indicate that a user wears shirts that are size medium, shoes that are size ten, etc. The user profile may be information previously stored or may be entered by the user right before sending the request. Also, the user may have an account with a provider associated with the electronic document 102 and the request may include login information. For example, a clothing company may provide a web page for ordering t-shirts. The user may register using the web page to obtain an account for storing user profile information and may obtain a user name and password to access the account. In response to the request, the web server 408 may retrieve the electronic document 102 and may determine that the content 104 of the electronic document 102 includes one or more inventory tags that can be used to instruct the web server 408 to determine if an item 106 associated with each inventory tag is currently available in inventory for purchase.

FIG. 5 illustrates a web server 408 in accordance with example embodiments of the present disclosure. The web server 408 may include a processor 502 and a memory 504. The memory 504 may store an electronic document database 506 that may store one or more electronic documents 102. The web server 408 may receive and process the request from the user terminal 404 to obtain an electronic document 102 from the electronic document database 506.

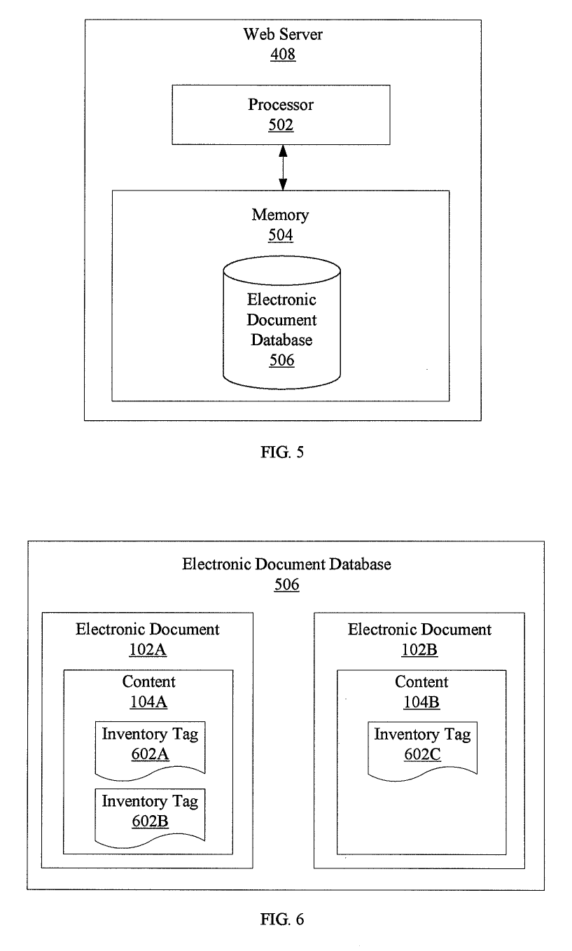

FIG. 6 illustrates the electronic document database 506 in accordance with example embodiments of the present disclosure. The electronic document database 506 may store one or more electronic documents 102. Each electronic document 102 may include content 104, which may include one or more inventory tags 602. An inventory tag 602 may represent that an item 106 displayed in the content 104 may be available for purchase. In the depicted example, the electronic document database 506 includes electronic document 102A and 102B. Electronic document 102A includes content 104A and inventory tags 602A and 602B. Electronic document 102B includes content 104B and inventory tag 602C.

An inventory tag 602 may be an identifier for instructing the web server 408 to determine the availability of an item 106 in inventory associated with the inventory tag 602 before transmitting the electronic document 102 to the user terminal 404. For example, the inventory tag 602 may be an instruction and may include a number/letter/symbol sequence to uniquely identify an item 106. In an example where the item 106 is an article of clothing, each item 106 may be associated with an identifier that is a style number, and the style number may be used to determine availability of that article of clothing. When an inventory tag 602 is identified in the electronic document 102, the web server 408 may generate an availability request that includes the inventory tag 602 and may transmit the availability request to the inventory server 406 via the network 402. Also, the inventory server 406 may periodically provide an inventory feed message to the web server 408 including the availability information on one or more tags for updating one or more electronic documents 102. The web server 408 may then examine the inventory feed message to obtain the availability information instead of or in addition to communicating the availability request to the inventory server 406.

The inventory tag 602 also may include a personality identifier and/or a posting user identifier. The personality identifier that may identify a person or entity included in the content 104 of the electronic document 102. The person may be some sort of personality or entity that is of interest to members of the public. Examples of personalities may include musicians, actors, politicians, athletes, etc.

The posting user identifier may identify who posted or uploaded the content 104 in the electronic document 102. For example, a social networking website may provide a computer application for download that permits its members to tag items 106 presented in their content 104. The member may create an electronic document 102 that is a webpage and may upload content 104 displaying an item 106, such as, but not limited to, the member wearing a pair of shoes. The computer application may permit the member to add an inventory tag 602 for each item presented in the uploaded content 104. The computer application may include a drop down menu having styles through which a user may navigate to identify the item 106 displayed in the content 104. The computer application may add an inventory tag 106 to the electronic document 102 that also includes a posting user identifier uniquely identifying the user who posted the content on the social networking website. If a predetermined number of sales (e.g., one or more) result from the content 104 posted by the member, the provider of the item 106 may reward the posting user with an incentive, such as, but not limited to, an affiliate fee or a reward. The incentive may be, for example, a coupon, points, cash, entry in a prize giveaway, merchandise credit, autographs, other incentives, and/or any combination thereof from sales that result from someone making a purchase after purchasing an item 106 presented in the content 104 posted by the member.

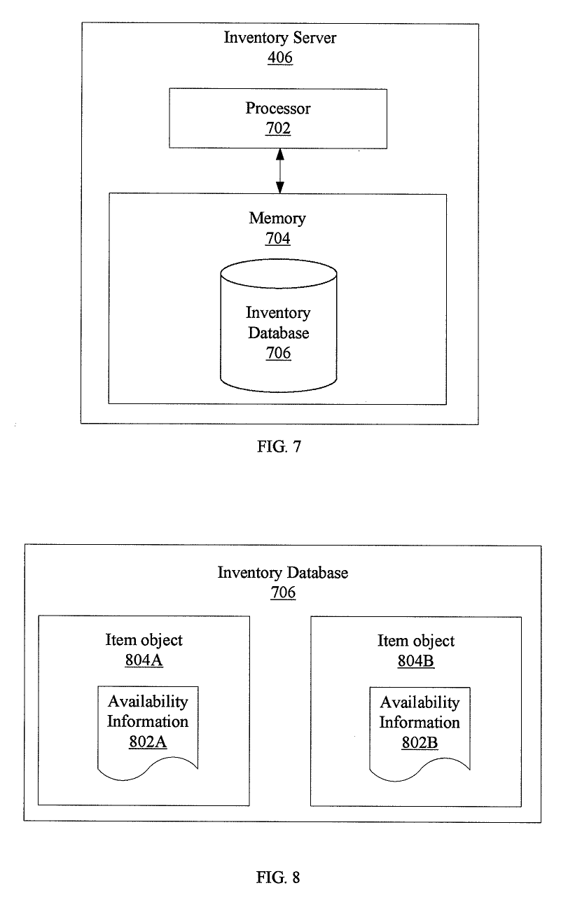

FIG. 7 illustrates the inventory server 406 in accordance with example embodiments of the present disclosure. The inventory server 406 may include a processor 702 and a memory 704. The memory 704 may store an inventory database 706 that may store information that indicates the availability of one or more items 106 in a provider's inventory. The inventory server 406 may receive the availability request and may query the inventory database 706 to obtain availability information associated with the inventory tag 602.

FIG. 8 illustrates the inventory database 706 in accordance with example embodiments of the present disclosure. The inventory database 706 may include one or more item objects 804. An item object 804 may include information about the availability of an item 106. For instance, an item object 804 may include availability information 802 that indicates whether an item 106 is currently in stock. The availability information 802 may generically indicate that an item 106 is available, and/or also may include further detailed information about the item 106. For instance, the availability information 802 may indicate that the item 106 is or is not available, the number currently in inventory, whether any additional items are expected to be received within a certain time period (e.g., the next couple of days, weeks, months, etc.), the availability of particular models or styles, what colors are available, any combination thereof, and so forth. If the item 106 is a shirt, the availability information 802 may include information at the style level (i.e., whether a particular style is available). The availability information 802 also may include information about which sizes are currently inventory, the number available in each size, and so forth. In the depicted example, the inventory database 706 includes item object 804A having availability information 802A and item object 804B having availability information 802B.

The inventory server 406 may receive and process the availability request having one or more inventory tags 602 to determine whether an item 106 associated with each inventory tag 602 is currently in inventory. The inventory server 406 may identify an item object 804 based on an inventory tag 602. For example, the inventory server 406 may query the inventory database 706 based on the identifier of the inventory tag 602 to identify an item object 804, and the inventory database 706 may return the availability information 802 from the item object 804. Once retrieved, the inventory server 406 may generate an inventory response including the availability information 802 associated with each of the inventory tags 602 included in the availability request and may communicate the inventory response to the web server 408.

Upon receipt, the web server 408 may update the electronic document 102 to include the availability information 802 and may communicate the electronic document 102 to the user terminal 404 via the network 402. Also, as mentioned above, the inventory server 406 may periodically provide an inventory feed message to the web server 408 including the availability information 802 on one or more tags 602 for updating one or more electronic documents 102 and may or might not include sending the availability request.

The user terminal 404 may receive the electronic document 102 and may present the electronic document 102 to a user. For example, the user terminal 404 may include a display and the user terminal 404 may present the electronic document 102 in the display as illustrated in FIGS. 1-3. The user may manipulate the user terminal 404 to cause the indicator 302 to be positioned above (i.e., hover) over an item 106 of interest. When the indicator 302 hovers above a field 202, the user terminal 404 may process the availability information 802 to determine whether to cause display of the purchasing link 304. If the availability information 802 indicates that the item 106 associated with the field 202 is in inventory, the user terminal 404 may cause display of the purchasing link 304. The user terminal 404 also may cause display of the number of items currently in inventory, whether any items are expected to be received within a certain time period, etc., if included in the availability information 802. The user may cause the indicator 302 to select the purchasing link 304 to input information to purchase the item 106 of interest. The user terminal 404 may then interact with the web server 408 to display images, etc. and process data to complete the purchase.

If the availability information 802 indicates that the item 106 is not in inventory, the user terminal 404 might not display the purchasing link 304. Also, if unavailable, the user terminal 404 may present the purchasing link 304 indicating that the item 106 is currently unavailable and may indicate whether the item 106 is expected to be available at some future time. As such, the system 400 may make determinations about the availability of an item 106 at the time an electronic document 102 is to be presented, and thus may determine whether to present a purchasing link 304 based on item availability.

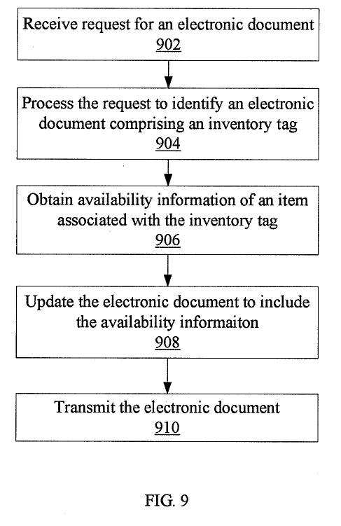

FIG. 9 illustrates a method to receive and respond to a request for an electronic document in accordance with example embodiments of the present disclosure. The method may begin at block 902.

In block 902, the method may include receiving a request from the user terminal 404 that requests an electronic document 102. In an example embodiment, the web server 408 may receive a request from the user terminal 404 for an electronic document 102 via the network 402.

In block 904, the method may include processing the request to identify the electronic document 102 comprising an inventory tag 602. In an example embodiment, the web server 408 may query the electronic document database 506 to identify an electronic document 102 associated with the request. The web server 408 may identify that the electronic document 102 includes one or more inventory tags 602.

In block 906, the method may include obtaining availability information 802 of an item 106 associated with the inventory tag 602. In an example embodiment, the web server 408 may generate an availability request that includes one or more inventory tag 602 of the electronic document 102 and may transmit the availability request to the inventory server 406. The inventory server 406 may process the availability request to query the inventory database 706 to identify an item object 804 associated with each of the inventory tags 602 to retrieve the availability information 802 of the one or more identified item objects 804. The inventory server 406 may generate an availability response including the availability information 802 of each of the identified item objects 804 and may transmit the availability response to the web server 408. Also, as mentioned above, the inventory server 406 may periodically provide an inventory feed message to the web server 408 including the availability information 802 on one or more tags 602 for one or more electronic documents 102 and may or might not include sending the availability request. The web server 408 may process the inventory feed message to obtain the availability information 802 of the item 106 associated with the inventory tag 602.

In block 908, the method may include updating the electronic document 102 to include the availability information 802.

In block 910, the method may include transmitting the electronic document 102 to the user terminal 404 via the network 402. The method of FIG. 9 may then end.

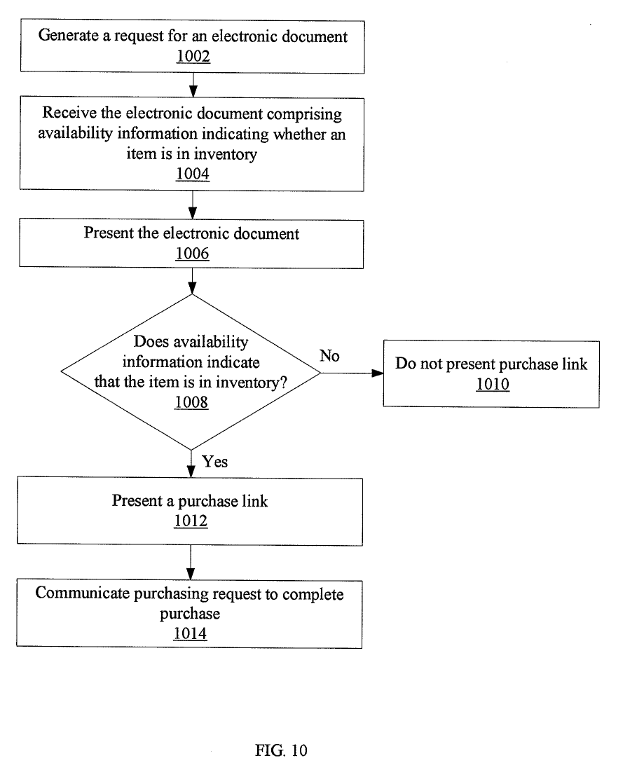

FIG. 10 illustrates a method for retrieving an electronic document in accordance with example embodiments of the present disclosure. The method may begin at block 1002.

In block 1002, the method may include generating a request for an electronic document 102. In an example embodiment, the user terminal 404 may generate a request for an electronic document 102. For example, the electronic document 102 may be a webpage and the user terminal 404 may use a web browser to retrieve the webpage.

In block 1004, the method may include receiving the electronic document 102 via the network 402 from the web server 408.

In block 1006, the method may include presenting the electronic document 102. In an example embodiment, the user terminal 404 may include a display for displaying the electronic document 102 to the user. The electronic document 102 may include availability information 802.

In block 1008, the method may include determining whether the availability information 802 indicates that an item 106 to be presented in content 104 of the electronic document 102 is available in inventory for purchase. If unavailable, the method may continue to block 1010. If unavailable, the method may continue to block 1012.

In block 1010, the method may include not presenting a purchasing link 304 if an indicator 302 is positioned relative to a field 202 associated with the item 106. In an example embodiment, with reference to FIG. 3, if the user causes the indicator 302 to be positioned relative to (e.g., co-locate) with the field 202 associated with the item 106A, the user terminal 404 may process the availability information 802 associated with the item 106A and, because the item 106A is unavailable, the user terminal 404 might not present the purchasing link 304. Referring again to block 1008, if the item 106 is available, the method may proceed to block 1012.

In block 1012, the method may include presenting a purchasing link 304 if the indicator 302 is positioned relative to (e.g., co-locates) a field 202 associated with an item 106. In an example embodiment, with reference to FIG. 3, if the user causes the indicator 302 to co-locate with the field 202 associated with the item 106A, the user terminal 404 may process the availability information 802 associated with the item 106A and, because the item 106A is available, the user terminal 404 may present the purchasing link 304. The user may then provide input to the user terminal 404 to cause selection of the purchasing link 304 to purchase the item 106.

In block 1014, the method may include communicating a purchasing request to complete the purchase. To purchase an item 106, the user may input information, such as, but not limited to, a credit card number and may transmit a purchasing request to a billing server (not shown) to complete the transaction. The purchasing request also may include a posting user identifier if the item 106 was posted by a particular user. The provider of the purchased item 106 may then give the posting user credit, as described above, based on the volume of sales generated from the content 104 posted by the user. The method of FIG. 10 may then end.

The following describes various examples for in accordance with example embodiments of the present disclosure.

In an example embodiment, a personality may provide content 104 for posting on an electronic document 102 that is a social networking website. The provider and a personality may enter into an agreement where the personality agrees to provide content 104 that includes one or more items 106 of the provider, and the provider agrees to pay the personality a royalty, which may be a fixed or variable amount depending on the number of items sold. For example, a provider may be a t-shirt company that produces items 106 that are t-shirts. The personality may make content 104, such as video or pictures, while wearing the t-shirts. The personality may provide the content 104 to the provider, which may appropriately code the electronic document 102 by including one or more fields 202 and corresponding inventory tags 602, and may post an electronic document 102 including the content 104. The provider also may include information in the inventory tag 602 to indicate the personality. The provider may pay the personality a royalty based on sales of the t-shirt shown in the content 104.

In another example embodiment, a first user may sign up to be a member of a social networking website and may create an electronic document 102 that is a webpage. A provider of one or more items 106 may develop a provider application (e.g., software or other computer program that may be embodied on a computer readable media) that permits the first user to create inventory tags 602 for items 106 in content 104 posted by the user on the webpage. The user terminal 404 may download the provider application and may receive input from the first user to create one or more fields 202 and associated inventory tags 602 for content 104 to be posted or already posted on the webpage. For example, the provider application may permit the first user to create a field 202 by using their indicator 302 to create a box (see fields 202A-C in FIG. 2, for example) to cover an item 106 and may provide a series of menus where the first user navigates to classify the item 106 (e.g., the style of a shoe, t-shirt, etc.). Once the user has classified the item 106, the provider application may cause the user terminal 404 to communicate the inventory tag 602 identifying the item 106 included in the content 104 and the posting user identifier to the social networking website. The social networking website may include the posting user identifier and the inventory tag 602 of the item 106 in the webpage.

When a second user views the content 104 having the item 106, if the item 106 is available in inventory, as described above, the electronic document 102 may present the purchasing link 304 that is associated with the posting user identifier. If the second user decides to purchase the item 106, a user terminal 404 of the second user may communicate a purchasing request that includes the posting user identifier to a billing server of the provider of the item 106. The provider may use the posting user identifier to identify the originator of the purchase (i.e., the first user who posted and tagged the item 106 in the content 104). The provider may then update incentive information associated with the posting user identifier. For instance, the provider may set up an account for the posting user and may add an affiliate fee (e.g., a percentage of the sale) or some other incentive for each sale.

As such, the systems and methods described herein provide content having fields and inventory tags to determine an availability of an item in inventory. The availability of the item may be used to determine whether to present a purchasing link to the user. This advantageously does not involve recoding of an electronic document based on availability of items in displayed content (i.e. no backwards administration of the electronic document), and instead, availability of items in content to be displayed may be determined at the time when the electronic document is to be presented to the user.

The foregoing description was provided with respect to determining whether to present a purchasing link to a user. It is understood that the principles described herein may be extended to similar decisions when presenting other types of information to a user.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method comprising:
receiving a request for an electronic document comprising content, wherein the request comprises user information;
retrieving the electronic document associated with the request;
processing, by a processor, the electronic document to identify an inventory tag that identifies an item in the content;
obtaining, by the processor, current availability information of the item associated with the inventory tag based on the user information;
updating, by the processor, the electronic document to include the current availability information; and
transmitting the electronic document including the current availability information.

2. The method of claim 1, further comprising transmitting an availability request including the inventory tag to an inventory server.

3. The method of claim 2, further comprising receiving an inventory response comprising the availability information from the inventory server.

4. The method of claim 1, wherein the current availability information indicates that the item is not in the inventory.

5. The method of claim 1, wherein the current availability information indicates that the item is in the inventory.

6. (canceled)

7. The method of claim 1, wherein the user information comprises sizing information of a user.

8. The method of claim 1, wherein the inventory tag is associated with a personality identifier for determining a royalty payment.

9. The method of claim 1, further comprising:
receiving a purchase request for purchasing the item, the purchase request comprising a posting user identifier; and
updating incentive information associated with the posting user identifier.

10. A computer readable media comprising computer-executable instructions which, when executed, cause a processor to perform a method comprising:
receiving a request for an electronic document comprising content, wherein the request comprises user information;
retrieving the electronic document associated with the request;
processing, by the processor, the electronic document to identify an inventory that identities an item in the content;
obtaining, by the processor, current availability information of the item associate with the inventory tag based on the user information;
updating, by the processor, the electronic document to include the current availability information; and
transmitting the electronic document including the current availability information.

11. An apparatus comprising:
a processor;
a memory having computer-executable instructions which, when executed, cause the apparatus to:
receive a request for an electronic document comprising content, wherein the request comprises user information;
retrieve the electronic document associated with the request;
process the electronic document to identify an inventory tag that identifies an item in the content;
obtain current availability information of the item associated with the inventory tag based on the user information;
update the electronic document to include the current availability information; and
transmit the electronic document including the current availability information.

12. The apparatus of claim 11, wherein the computer-executable instructions which, when executed, further cause the apparatus to transmit an availability request including the inventory tag to an inventory server.

13. The apparatus of claim 12, wherein the computer-executable instructions which, when executed, further cause the apparatus to receive an inventory response comprising the current availability information from the inventory server.

14. The apparatus of claim 11, wherein the computer-executable instructions which, when executed, further cause the apparatus to:
receive a purchase request for purchasing the item, the purchase request comprising a posting user identifier; and
update incentive information associated with the posting user identifier.

15. A method comprising:
generating, by a processor, a request for an electronic document comprising content;
receiving the electronic document comprising availability information indicating whether an item to be presented in the content is in inventory;
presenting the electronic document comprising a field associated with the item;
determining that an indicator is positioned relative to the field;
processing, by the processor, the availability information to determine if the item is in inventory in response to the indicator being positioned relative to the field: and either;
presenting a link in the electronic document to permit purchase of the item in response to determining that the item is in the inventory; or
determining not to present the link in the electronic document in response to determining that the item is not in the inventory.

16. The method of claim 15, further comprising presenting a prompt requesting information to populate a user profile.

17. The method of claim 16, wherein the information comprises sizing information.

18. The method of claim 15, wherein the indicator is controlled by a user input device.

19. The method of claim 18, wherein the user input device is a keypad, a computer mouse, or a tracking ball.

20. A computer readable media comprising computer-executable instructions which, when executed, cause a processor to perform a method comprising:
generating, by the processor, a request for an electronic document comprising content;
receiving the electronic document comprising availability information indicating whether an item to be presented in the content is in inventory;
presenting the electronic document comprising a field associated with the item;
determining that an indicator is positioned relative to the field;
processing, by the processor, the availability information to determine if the item is in inventory in response to the indicator being positioned relative to the field: and either;
presenting a link in the electronic document to permit purchase of the item in response to determining that the item is in the inventory; or
determining not to present the link in the electronic document in response to determining that the item is not in the inventory.

21. An apparatus comprising:
a processor;
a memory having computer-executable instructions which, when executed, cause the apparatus to:
generate a request for an electronic document comprising content;
receive the electronic document comprising availability information indicating whether an item to be presented in the content is in inventory;
present the electronic document comprising a field associated with the item;
determining that an indicator is positioned relative to the field;
processing the availability information to determine if the item is in inventory in response to the indicator being positioned relative to the field: and either;
presenting a link in the electronic document to permit purchase of the item in response to determining that the item is in the inventory; or
determining not to present the link in the electronic document in response to determining that the item is not in the inventory.

22. The apparatus of claim 21, wherein the computer-executable instructions which, when executed, further cause the apparatus to present a prompt requesting information to populate a user profile.

23. A method comprising:
receiving content for presentation in an electronic document;
receiving an inventory tag identifying an item included in the content, the inventory tag being associated with a posting user identifier;
receiving a purchase request for the item, the purchase request comprising the posting user identifier; and
updating incentive information associated with the posting user identifier.

24. The method of clam 23, wherein the updating of the incentive information comprises payment of an affiliate fee.

25. A computer readable media comprising computer-executable instructions which, when executed, cause a processor to perform the method of claim 23.

26. An apparatus comprising:
a processor;
a memory having computer-executable instructions which, when executed, cause the apparatus to:
receive content for presentation in an electronic document;
receive an inventory tag identifying an item included in the content, the inventory tag being associated with a posting user identifier;
receive a purchase request for the item, the purchase request comprising the posting user identifier; and
update incentive information associated with the posting user identifier.
